(19) United States
(12) Patent Application Publication
(10) Pub. No.: US 2005/0244682 A1
(43) Pub. Date: Nov. 3, 2005

(54) Thermally integrated internal reforming fuel cells

(76) Inventor: G.B Kirby Meacham, Shaker Heights, OH (US)

Correspondence Address: Peter F. Corless;EDWARDS & ANGELL, LLP, P.O. Box 55874, Boston, MA, 02205, US

(21) Appl. No.: 10/835,202

(22) Filed: Apr. 28, 2004

(51) Int. Cl. H01M 8/04; H01M 8/06; H01M 8/24

(52) U.S. Cl. 429/17; 429/26; 429/32; 429/19; 429/38; 429/39

(57) ABSTRACT

A bipolar fuel cell stack is provided, along with a method for two-stage internal reforming in fuel cells, in which electric power can be generated from the reaction of hydrocarbon fuel with oxidant gases in the fuel cells. The fuel cell stack can include two or more electrochemical fuel cells in thermal contact to provide direct internal reforming. The fuel is reformed and partially utilized to produce electric power in a set of first stage cells, and further utilized to generate additional electric power in a set of second stage cells. In the first stage cells, the fuel is actively mixed with products of reaction over the anode to limit fuel concentration and suppress soot formation. The first stage exhaust then passes through the second stage cells in plug flow mode to increase fuel utilization.

### FIELD OF THE INVENTION

The present invention relates to fuel cells and integrated systems including solid oxide fuel cells and stack designs, and in particular, to reforming of methane, higher hydrocarbon, and alcohol liquid and gas fuels that are consumed in fuel cells.

### BACKGROUND OF THE INVENTION

Fuel cells are electrochemical systems that generate electrical current by chemically reacting a fuel gas and an oxidant gas on opposite surfaces of electrodes. Conventionally, the components of a single fuel cell include an anode, a cathode, an electrolyte, and interconnect material. In solid state fuel cells, such as high temperature solid oxide fuel cells (SOFCs), the electrolyte is in a solid form and insulates the cathode and anode from each other with respect to electron flow, while permitting oxygen ions to flow from the cathode to the anode. The interconnect material is a gas barrier that electronically connects the anode of one cell with the cathode of an adjacent cell, in series, to generate a useful voltage from an assembled fuel cell stack. The SOFC can directly utilize hydrogen and carbon monoxide as fuel gases, and oxygen or air as an oxidant. One or more fuel gases and oxidants react on the active electrode surfaces of the cell to produce electrical energy, water vapor, carbon dioxide, and heat.

In some applications, in which hydrogen and/or carbon monoxide are not readily available, commonly available substitutes can be used, including fuel methane, higher gaseous and liquid hydrocarbons, and alcohols. Such fuels are generally referred to as “hydrocarbons” in the following discussion and descriptions. Likewise air, oxygen, and various mixtures containing oxygen are generally referred to as “oxidants” in the following discussion and descriptions.

Hydrocarbons may be converted into hydrogen and carbon monoxide by well-known processes such as steam reforming and partial oxidation reforming. Steam reforming is an endothermic reaction that adds hydrogen and oxygen to the hydrocarbon fuel in the form of steam, thereby producing a mixture of hydrogen and CO and/or CO₂. Steam must be generated and sensible heat must be transferred to the reaction site. The sensible heat is often “free” since it is obtained from a fuel cell exhaust gas burner, but the heat transfer surfaces are typically large and constructed of costly high temperature alloys. U.S. Pat. No. 5,938,800 to Verrill et al. describes one type of steam reformer.

Partial oxidation reforming is a slightly exothermic reaction that adds oxidant and optionally steam directly to the hydrocarbon fuel, and produces a mixture of hydrogen and CO and/or CO₂. An advantage of partial oxidation reforming is that sensible heat transfer is not required, but one drawback is that a portion of “expensive” fuel energy is used to drive the endothermic reaction.

An alternative to conventional reforming processes incorporates internal reforming within a cell. Hydrocarbons have been shown to react at the SOFC nickel anode surface without forming soot (elemental carbon) when water vapor, CO₂, and heat are present. The hydrocarbon molecules are broken down to form hydrogen and carbon monoxide according to a classic endothermic steam reforming reaction catalyzed by the nickel anode. Water vapor, CO₂, and heat formed at the site by a power generation reaction drive the reaction. The hydrogen and carbon monoxide then react to generate power, and the reaction products replace the water vapor, CO₂ and heat consumed by reforming to sustain the process. The overall reaction is fuel oxidation, but water vapor, CO₂ and heat must be present in an adjunct role to break down the fuel molecules. This internal reforming is potentially simpler and more efficient than using a separate reformer, and also helps to cool the cell. Internal reforming in SOFC systems is described, e.g., in U.S. Pat. No. 6,230,494 to Botti et al.

The fuel in prior art SOFCs typically must pass across the anode surface from an inlet region to an exit region in plug flow mode. Plug flow mode is characterized by fluid elements moving over the anode in an orderly first-in, first-out sequence with minimal mixing. The sequence is important to prevent fresh inlet fuel from exiting prematurely without passing over the entire anode. Power generation reactions progressively consume the fuel, and gas composition and temperature typically change as the fuel passes over the anode. Approximately 80% of the fuel is utilized by the time the fuel reaches the exit region. The fuel remaining at the exit is typically burned to preheat the incoming fuel and air streams, supplied as steam reforming heat, or put to other uses. High fuel utilization is important to achieve high overall power generation efficiency, but technical and economic factors tend to limit power generation efficiency. Excessively high fuel utilization may cause oxidation damage to the metallic anode near the exit region, since the depleted fuel no longer maintains a protective reducing environment. High utilization also requires increased cell area operating at low power density in the depleted fuel areas, thus increasing cell size and cost without a commensurate increase in power output. Certain prior art SOFCs attempt to balance these factors to achieve design objectives.

In prior art SOFCs, operating in plug flow mode can lead to difficulties when using unreformed hydrocarbon fuel. Reforming is inhibited at the fuel inlet region since the fuel tends to sweep away water vapor and CO₂. Contact between the hydrocarbon and the anode may cause soot formation under these conditions. In addition, onset of the endothermic reforming reaction may cause localized cooling, inhibiting reforming and power generation reactions. The conventional solution has been to utilize partial pre-reforming to add some H₂ and CO to the fuel entering the SOFC. Power generation and internal reforming then have sufficient ingredients to start immediately, and the balance of the hydrocarbon fuel is internally reformed. This solution has proven effective, but leads to increased system cost, size, and complexity. U.S. Pat. No. 5,082,751 to Reichner, for example, describes a system in which catalyst-filled reformers are in intimate contact with fuel cells, such that fuel cell sensible heat drives the endothermic reaction. In Reichner, a water vapor and reformable fuel mixture is passed through the reformers before contacting the fuel cells.

Recycling and mixing a portion of the fuel exhaust with the incoming fuel has also been used to help start the power generation and internal reforming reactions. This recycled exhaust typically contains water vapor, H₂, CO₂, CO, and heat, establishing the necessary conditions to start and sustain internal reforming. One system that utilizes this technique is described in U.S. Pat. No. 6,344,289 to Dekker et al., which describes multiple cell stacks with cathode flows connected in series, but where the anode flows are in parallel, not series. One objective of the anode gas recycling disclosed in Dekker is the suppression of carbon formation, without requiring steam injection.

It is also known to connect internal reforming cell stacks such that fuel flows in series from the anode of one stack to the anode of the next stack. For example, U.S. Pat. No. 5,993,984 to Matsumura et al. describes a system in which anode exhaust from one stack is passed through a methanator to remove heat and raise the methane content by an exothermic reaction. Internal reforming of the methane in the next stack provides endothermic cooling while increasing overall fuel utilization.

U.S. Pat. No. 6,162,556 to Vollmar et al. describes a high temperature fuel cell thermally integrated with a reformer that produces excess hydrogen beyond what the fuel cell uses. This excess hydrogen may be used for other purposes including as fuel for additional fuel cells. According to the method of Vollmar, fuel is vaporized, water is injected, and the resulting gas mixture is passed through the reformer into the fuel cell where it is partially utilized in an electrochemical power generation reaction. It should be noted that internal reforming is not used in Vollmar, and the water is added from an external source for reforming.

Published PCT Application No. PCT/US02/05853 (published under publication number WO 02/069430—hereinafter “the '430 publication”) by the inventor of the present application is incorporated by reference herein. The '430 publication describes an improved method and apparatus for internal reforming in fuel cells. A two-stage process replaces the single-stage plug flow operation typical of prior art fuel cells in which fuel moves across the anode in a first-in, first-out sequence. According to the two-stage process disclosed in the '430 publication, in the first stage, unreformed hydrocarbon fuel is mixed with the products of reaction over the anode such that an endothermic reforming reaction takes place. As a result, the temperature and composition of the mixture of the hydrocarbon fuel and reaction products is relatively uniform between inlet and outlet regions. This uniformity at the inlet and outlet regions substantially eliminates that prevalence of localized fuel-rich areas of the fuel cell that contain insufficient water vapor, CO₂ and heat, and as a consequence facilitates reforming and suppresses soot formation. In the first stage, the fuel is partially oxidized and power is generated. The heating value of the fuel in the first stage exit flow to the inlet of the second stage is only partially utilized, on the order of approximately 40% to 60%, where the reactor exhaust contains a partially reformed mixture of hydrogen, carbon monoxide, CO₂, water vapor and hydrocarbon fuel. The second stage is operated in plug flow mode to increase the utilization to about 80%. Since the inlet gas is partially reformed, reforming is completed in the second stage without soot formation or excessive local cooling, and additional power is generated. The second stage reaction is exothermic, resulting in cathode air heating. The first and second stages preferably utilize separate cell stacks, and cathode exhaust air from the second stage stack may be used as inlet air to the first stage stack. This has the effect of transferring heat from the exothermic reaction in the second stage stack to the endothermic reforming reaction in the first stage stack. Conductive heat transfer between the stages is not utilized.

The present invention improves on the two-stage reforming process disclosed in the '430 publication by integrating the two stages into a single cell stack. Particular advantages include conductive heat transfer between the stages and a simplified system layout.

### SUMMARY OF THE INVENTION

The present invention is directed to a bipolar fuel cell stack and an improved method for two-stage internal reforming in fuel cells. According to the method, electric power is generated from the reaction of hydrocarbon fuel with oxidant gases in the fuel cells. A fuel cell stack according to the present invention can include two or more electrochemical fuel cells in thermal contact. Preferably, at least one of the fuel cells produces heat, and at least one of the fuel cells consumes heat.

Rather than forming separate stacks, one or more first stage cells (heat-consuming fuel cells) and one or more second stage cells (heat-producing fuel cells) can alternate in a single bipolar stack such that the cells are serially connected, and the cell voltages are added together to form the total stack voltage.

Conductive heat transfer between the first stage and the second stage cells is facilitated by the intimate contact between the alternating cells in the stack. The close contact between the first stage cells and the second stage cells can supplement or replace the use of cathode gas to transfer heat from the second stage to the first stage, thereby providing a high degree of thermal integration.

In the first stage cells, hydrocarbon fuel is mixed with the products of reaction over the anode, thereby reforming the fuel. By permitting mixing over the entire surface of the anode, the temperature and composition of the mixture of the hydrocarbon fuel and reaction products can be maintained relatively uniform, thereby substantially eliminating the presence of localized fuel-rich areas with insufficient water vapor, CO₂, or heat. As a result, soot formation is suppressed, and reforming action is optimized. In the first stage cells, the fuel is partially oxidized and power is generated. The endothermic reforming reaction uses heat formed by the first stage power generation reaction and additional heat transferred from the second stage cells. The energy content of the fuel leaving the first stage cells and entering the second stage cells is only partially utilized, about 40% to 60%. Such fuel constitutes a partially reformed mixture of hydrogen, carbon monoxide, CO₂, water vapor, and hydrocarbon fuel. The second stage cells preferably are operated in plug flow mode to increase the fuel utilization to about 80%. Since the gas is partially reformed, any necessary reforming is completed in the second stage without soot formation or excessive local cooling, and additional power is generated.

Another aspect of the present invention is to provide a mechanism for mixing hydrocarbon fuel with reaction products in the flow passages over the anode in the first stage cells. Suitable mixing mechanisms include blower-driven recirculating loop flow, jet pump recirculating loop flow, and piston driven reversing flow.

Yet another aspect of the present invention is to route the oxidant gas through the second stage cells and then through the first stage cells such that sensible heat from the second stage cells is used to drive the endothermic reforming reaction in the first stage cells.

An advantage of the present invention is that commonly available hydrocarbon fuels can be utilized in a fuel cell with minimal auxiliary equipment such as reformers and heat exchangers. This in turn leads to power generation systems with size, weight and cost advantages compared to prior art systems.

Upon examination of the following detailed description the novel features of the present invention will become apparent to those of ordinary skill in the art or can be learned by practice of the present invention. It should be understood that the detailed description of the invention and the specific examples presented, while indicating certain embodiments of the present invention, are provided for illustration purposes only. Various changes and modifications within the spirit and scope of the invention will become apparent to those of ordinary skill in the art upon examination of the following detailed description of the invention and claims that follow.

### BRIEF DESCRIPTION OF THE DRAWINGS

The appended claims set forth those novel features which characterize the invention. However, the invention itself, as well as further objects and advantages thereof, will best be understood by reference to the following detailed description taken in conjunction with the accompanying drawings, where like reference characters identify like elements throughout the various figures, in which:

FIG. 1 is a schematic drawing illustrating a bipolar fuel cell stack used in an integrated two-stage internal reforming process according to the present invention;

FIG. 2 is a schematic drawing illustrating a bipolar fuel cell stack having a blower drive loop flow according to the present invention;

FIG. 3 is a schematic drawing illustrating the first cycle of a cyclic flow embodiment of the present invention;

FIG. 4 is a schematic drawing illustrating the second cycle of the cyclic flow embodiment of FIG. 3 according to the present invention; and

FIG. 5 is a schematic drawing illustrating a bipolar fuel cell stack with two second stage cells associated with each first stage cell, according to the present invention.

### DETAILED DESCRIPTION OF THE INVENTION

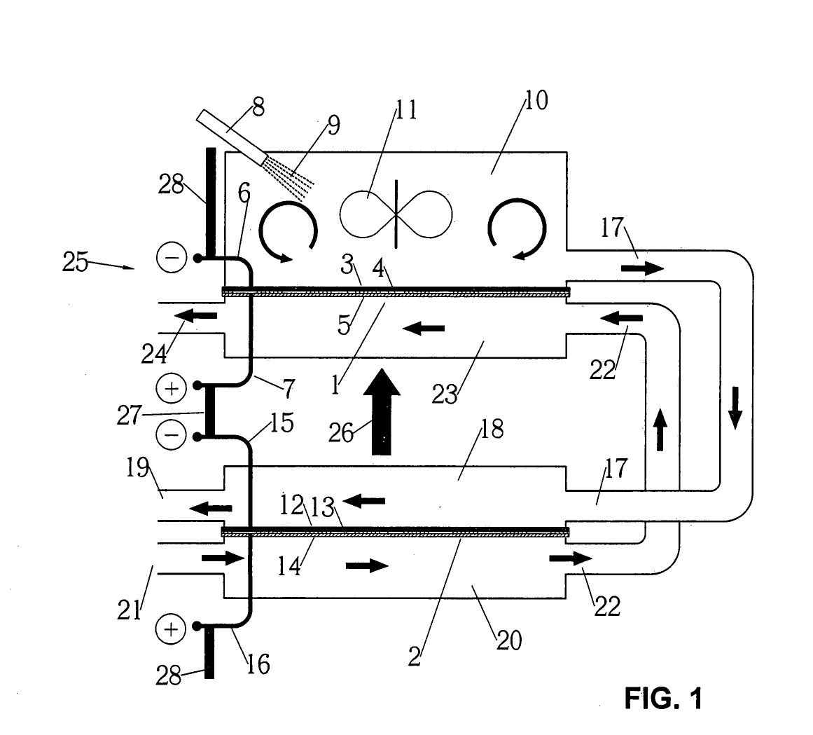

The present invention is directed to a bipolar fuel cell stack, including two or more electrochemical fuel cells in thermal contact, and a method of producing electric power from the reaction of hydrocarbon fuel with oxidant gas in the fuel cells. FIG. 1 is a schematic drawing illustrating an integrated two-stage internal reforming process, in which hydrocarbon fuel is vigorously mixed with the reaction products in a first set of fuel cells to facilitate fuel reforming. A second set of fuel cells operates in plug flow mode, thereby receiving fuel exhaust from the first set of fuel cells to achieve high fuel utilization. The first set of fuel cells (i.e., heat-consuming fuel cells) can receive sensible heat from the second set of fuel cells (i.e., heat-producing fuel cells), thus driving the endothermic fuel reforming reaction that takes place in the first set of fuel cells.

As shown in FIG. 1, a single first stage cell 1 and a single second stage cell 2 are connected via transfer passages, but where each of the first stage cell 1 and the second stage cell 2 can include one or more fuel cells. The first stage cell 1 preferably is a layered structure having at least an anode 3, an electrolyte 4, and a cathode 5, which are well known components of fuel cells, and therefore will not discussed in further detail. Power collection conductors 6 and 7 contact the anode 3 and the cathode 5, respectively. An injector 8 introduces hydrocarbon fuel 9 into a chamber 10 adjacent to the anode 3 of the first stage cell 1, where the hydrocarbon fuel is mechanically mixed with reaction products (e.g., water vapor and CO₂) expended by the anode as a result of the power generation reaction. Although a mechanical mixer 11 is depicted in FIG. 1, the mixer 11 can be replaced by any of a number of well known mixing mechanisms, such as a blower, jet pump, or magnetic or static mixer, without departing from the spirit or scope of the present invention.

The second stage cell 2 can be a layered structure having at least an anode 12, an electrolyte 13, and a cathode 14, which are well known components of fuel cells, and thus will not be discussed in further detail. Power collection conductors 15 and 16 contact the anode 12 and the cathode 14, respectively.

In the bipolar fuel cell stack depicted in FIG. 1, fuel gas flows from the chamber 10 of the first stage cell 1 through a transfer passage 17 to a chamber 18 adjacent the anode 12 of the second stage cell 2, and exits the bipolar fuel cell stack through a fuel exhaust passage 19. The fuel gas flow along the second stage anode 12 preferably is provided as unmixed plug flow. Oxidant can be introduced into a chamber 20 adjacent to the cathode 14 of the second stage cell 2 via an inlet passage 21. The oxidant preferably flows along the cathode 14 and then through a transfer passage 22 to a chamber 23 adjacent to the first stage cathode 5, flows along the cathode 5, and exits through an oxidant exhaust passage 24.

According to the present invention, the first stage cell 1 and the second stage cell 2 preferably are stacked in close proximity to form a plurality of subassemblies 25, where each fuel cell represents a single subassembly 25. Due to this closely stacked arrangement, sensible heat 26 can be transferred between the first stage cell 1 and the second stage cell 2. Also by this arrangement, electrical contact 27 is formed between a first stage cell cathode power collection conductor 7 and a second stage cell anode power collection conductor 15, such that the voltage between a first stage cell anode power collection conductor 6 and a second stage cell cathode power collection conductor 16 is about equal to the sum of the voltages of the first stage cell 1 and the second stage cell 2. Additional subassemblies 25, or fuel cells, can be combined in series to provide higher voltage and power output. Electrical contacts 28 extending from the first stage cell anode power collection conductor 6 of one subassembly 25 and the second stage cell cathode power collection conductor 16 of an adjacent subassembly 25, respectively, provide the required interconnections.

The bipolar fuel cell stack depicted in FIG. 1 can be operated in the following manner. Hydrocarbon fuel 9 preferably is added to the chamber 10 and mixed with preexisting reaction products by the mechanical mixer 11. By mixing the fuel 9 and reaction products, it is possible to avoid localized chilling effects or high local hydrocarbon fuel concentrations in the chamber 10. Unreformed fuel reacts with the steam, CO₂, and heat in the chamber 10 to produce at least H₂ and CO, which generate electric power. The anode 3 will typically catalyze this reaction, although additional catalytic material may be positioned in contact with the gas mixture. The power reaction in turn replaces the steam, CO₂, and heat. The overall reaction preferably is fuel oxidation, and the steam and CO₂ act as catalysts and are not consumed. Heat is a limiting factor, and heat may have to be conserved or added in some cases. The concentration of fuel relative to the reaction products is controlled by the volume of the chamber 10, the rate of fuel addition, and the rate at which power generation produces products of reaction at the anode. By varying these parameters, it is possible to adjust the fuel concentration such that soot-free fuel reforming is achieved for a variety of fuel compositions.

Introduction of hydrocarbon fuel 9 into the chamber 10 increases the quantity of gas in the chamber 10 and causes excess mixed fuel and reaction products to flow out through the transfer passage 17 into the second stage cell 2. Fuel utilization is less than about 50% in the first stage cell 1, so the gas flows along the second stage cell anode 12 in plug flow mode to complete the reforming reaction and increase fuel utilization to about 70 to 80%. The depleted fuel gas exits the second stage cell 2 through the fuel exhaust passage 19. The sensible heat and remaining heating value may be recovered by utilizing the combination of a burner and a heat exchanger, e.g., in order to preheat the inlet oxidant stream. It should be noted that with series connection of the fuel cells, the electric current through each cell is the same, although the voltage across each cell is generally different. Parallel connection of cells with different voltages results in energy loss, and is less desirable than the series connection depicted in FIG. 1.

Preheated oxidant enters the second stage cell 2 through the inlet passage 21, and then flows through the chamber 20 and contacts the cathode 14. The chemical potential difference between the oxidant at the cathode 14 and the fuel mixture at the anode 12 generates a voltage across the electrolyte 13 and an external current flow through power collection conductors 15 and 16. Oxygen from the oxidant passes through the electrolyte 13 in the form of ions, and oxidizes hydrogen and CO at the anode 12 to form water vapor and CO₂. Sensible heat 26 (as depicted by the arrow in FIG. 1) can flow from the second stage cell 2 to the first stage cell 1, where it may be used in the endothermic fuel reforming reaction taking place on anode 3.

Also, partially depleted oxidant flows from the second stage cell 2 through the transfer passage 22, and then flows through the chamber 23 and contacts the cathode 5. The chemical potential difference between the oxidant at the cathode 5 and the fuel mixture at the anode 3 generates a voltage across the electrolyte 4 and an external current flow through power collection conductors 6 and 7. Sensible heat in the partially depleted oxidant stream may be transferred through the layers of the first stage cell 1 to provide additional heat to drive the endothermic reforming reaction taking place on the anode 3. Depleted oxidant gas exits the first stage cell 2 through the oxidant exhaust passage 24. The sensible heat and remaining oxidant value may be recovered by utilizing the combination of a burner and a heat exchanger, e.g., in order to preheat the inlet oxidant stream

In cases in which reforming heat is the limiting factor, a controlled amount of air may be added to the first stage cell 1 along with the hydrocarbon fuel 9. Air addition may also be used to provide additional heat during start-up, part-load operation, or any other condition where additional heat is needed to sustain operation.

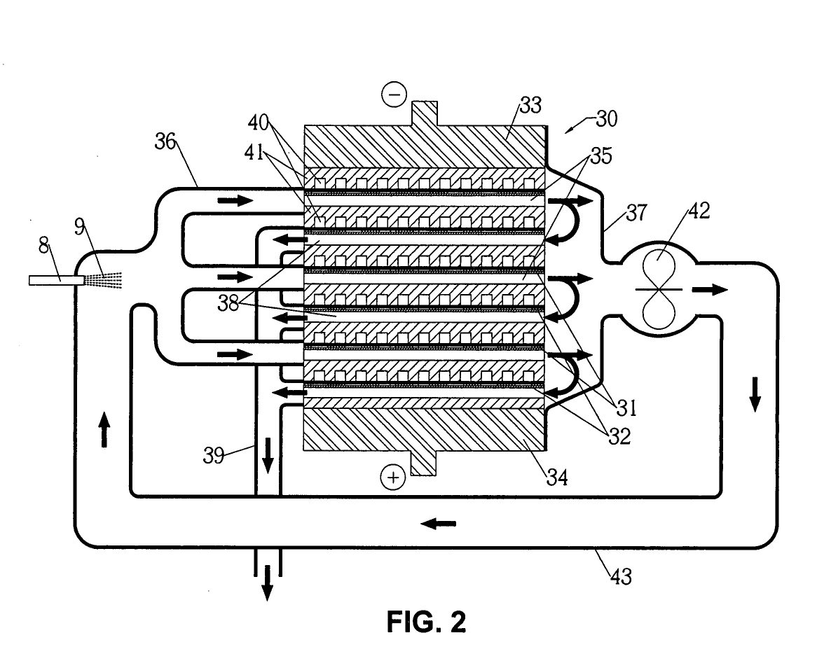

The above-described operation of the present invention can be implemented using various different apparatus, and can be applied to any reformable fuel. The present invention provides significant advantages over prior art techniques such as conventional steam reforming or POX reforming, since electric power is generated during operation of the present invention. The fuel 9 can be selected from commonly available fuels such as methane, higher gaseous and liquid hydrocarbons, and alcohols. By providing a mixer 11 to mix the fuel 9 in the chamber 10 of the first stage cells 1, reforming is stimulated, whereby electrochemical oxygen is added to the hydrocarbon fuel 9. Moreover, by maintaining the first stage cells 1 and the second stage cells 2 in close physical proximity, thermal integration is achieved, whereby the second stage cells 2 are cooled and also drive the reforming reaction in the first stage cells 1. FIGS. 2-5 provide examples of systems that implement the invention described above with reference to FIG. 1.

FIG. 2 is an example of a system that uses recirculating loop flow mixing, according to the present invention. A cell stack 30 having a cross-flow bipolar design is formed of first stage cells 31 alternating with second stage cells 32. Conductive separator plates 41 are arranged between the first and second stage cells 31 and 32 to prevent mixing of fuel gas streams and oxidant streams, while electrically connecting the cells in series. The cells and separator plates are clamped between power takeoff plates 33 and 34. First stage anode passages 35 provided in the separator plates 41 permit fuel gas to flow from a fuel inlet manifold 36 to a fuel transfer manifold 37, such that the fuel flows along and contacts an anode layer of each first stage cell 31. Second stage anode passages 38 are arranged in the separator plates 41 to allow flow of fuel gas from the fuel transfer manifold 37 to a fuel exhaust manifold 39, such that the fuel flows along and contacts the anode layer of each second stage cell 32.

Cathode passages 40 are formed in the separator plates 41, and extend generally perpendicular to the anode passages 35 and 38. The cathode passages pass between the cells 31 and 32, and allow flow of oxidant from an oxidant inlet manifold (not shown) to an oxidant exhaust manifold (not shown). A hot blower 42 and a loop flow duct 43 recirculate a portion of the fuel and reaction product mixture from the fuel transfer manifold 37 to the inlet fuel manifold 36. Hydrocarbon fuel 9 is added to the recirculated mixture by an injector 8 preferably positioned upstream of the fuel inlet manifold 36. The remainder of the fuel and reaction product mixture flows from the fuel transfer manifold 37 into the second stage anode passages 38.

Operation of the recirculating loop flow mixing system depicted in FIG. 2 will now be described. The hot blower 42 creates a recirculating loop flow through the first stage anode passages 35. Fuel 9 is added upstream of the first stage stack fuel inlet manifold 36, such that the fuel 9 is carried into the first stage anode passages 35. The volume of loop flow is large compared to the amount of fuel added, with the result being that the unreformed fuel entering the stack has a low concentration relative to the reaction products. Another result is that the loop flow transfers heat from hot areas to cool areas within the cells, thereby making the temperature more uniform. The net effect of the loop flow is that incoming fuel is mixed with the reaction products, facilitating reforming and eliminating soot formation.

A practical benefit of loop flow is that the hot blower 42 that provides the mechanical mixing is positioned outside the fuel cell stack and therefore can serve multiple cells. By adding the fuel 9 to the recirculating flow, and enabling reforming and power generation reactions to take place, the quantity of recirculating gas is increased according to the present invention. Any excess gas can flow from the fuel transfer manifold 37 into the second stage anode passages 38. The gas passes once through the second stage anode passages 38 in plug flow mode to increase fuel utilization and power generation, and is exhausted through the fuel exhaust manifold 39. Oxidant is passed through the cathode passages 40 in the cell stack 30. Various oxidant flow arrangements may be used, although a preferred arrangement is to first pass the oxidant through the second stage cells 32 where it is heated, and then through the first stage cells 31 where this heat may be utilized to drive the endothermic reforming reaction.

While a mechanical hot blower 42 is depicted in FIG. 2, other pump types such as a fuel jet driven venturi pump can be used. In a fuel jet driven venturi pump, fuel jet momentum is transferred by mixing a fuel and reaction product mixture in the venturi, thereby generating a recirculation flow. This provides a mechanically simple circulation pump with no moving parts that is particularly suitable for systems operating on compressed gaseous hydrocarbon fuel.

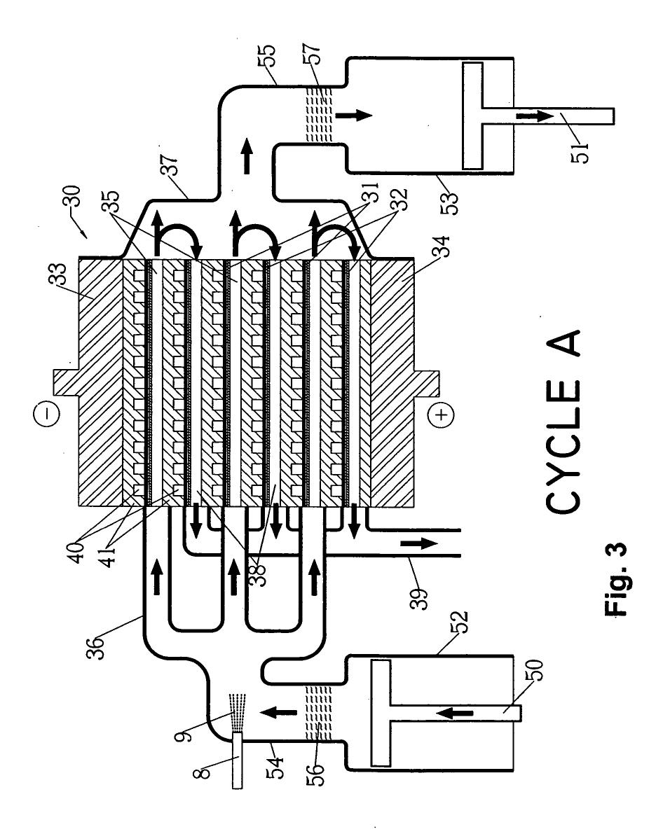

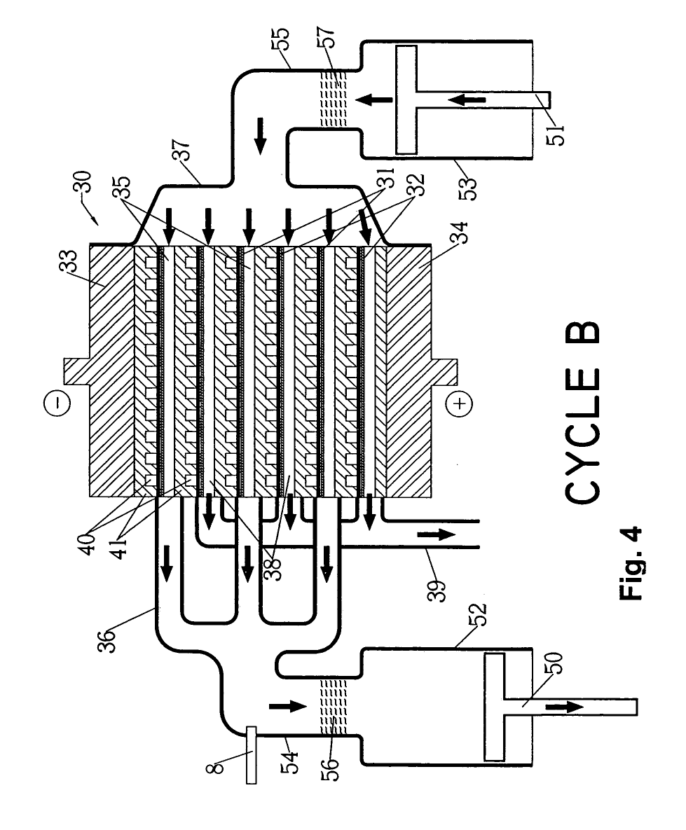

FIGS. 3 and 4 depict a system that utilizes push-pull flow mixing, according to the present invention. FIGS. 3 and 4 include a cell stack 30 arranged in a manner similar to the cell stack 30 in FIG. 2. The cell stack 30 preferably has a cross-flow bipolar design that is formed of first stage cells 31 alternating with second stage cells 32. Conductive separator plates 41 are arranged between the first and second stage cells 31 and 32 to prevent mixing of fuel gas streams and oxidant streams, while electrically connecting the cells in series. The cells and separator plates are clamped between power takeoff plates 33 and 34. First stage anode passages 35 provided in the separator plates 41 permit fuel gas to flow from a fuel inlet manifold 36 to a fuel transfer manifold 37, such that the fuel flows along and contacts an anode layer of each first stage cell 31. Second stage anode passages 38 are arranged in the separator plates 41 to allow flow of fuel gas from the fuel transfer manifold 37 to a fuel exhaust manifold 39, such that the fuel flows along and contacts the anode layer of each second stage cell 32.

Cathode passages 40 are formed in the separator plates 41, and extend generally perpendicular to the anode passages 35 and 38. The cathode passages pass between the cells 31 and 32, and allow flow of oxidant from an oxidant inlet manifold (not shown) to an oxidant exhaust manifold (not shown). A first displacer piston 50 and a second displacer piston 51 are positioned in cylinders 52 and 53, respectively, such that sliding seals are formed between the pistons and cylinder walls. A mechanism (not shown) moves each piston up and down within its respective cylinder in a controlled sequence. A duct 54 connects the volume enclosed by the first displacer piston 50 and the cylinder 52 to the fuel inlet manifold 36. Similarly, duct 55 connects the volume enclosed by the second displacer piston 51 and the cylinder 53 to the fuel transfer manifold 37. Optionally heat exchange media 56 and 57 can be positioned in the ducts 54 and 55, respectively. The heat exchange media preferably are high surface area solid structures through which gas can flow. The media store sensible heat, and if the gas temperature is higher than a heat exchange media temperature, heat flows from the gas to the media. If instead the gas temperature is lower than the media temperature, heat flows from the media to the gas. The heat exchange media can be constructed from various materials including, for example, metal or ceramic pellets, metal or ceramic fibers, monolithic porous metal or ceramic, and woven metal wire.

As shown in FIGS. 3 and 4, hydrocarbon fuel 9 is injected by an injector 8 into the inlet fuel manifold 36. This injection can involve multiple intermittent pulses in a timed relationship to the motions of the displacer pistons 50 and 51. Additional ducts (not shown) provide oxidant flow to the cathode passages 40 of the cell stack 30. It should be noted that the use of other known fluid displacement mechanisms such as diaphragms and bellows instead of displacer pistons and cylinders are within the scope of the invention.

Operation of the push-pull flow mixing system is described with reference to FIGS. 3 and 4. The present invention is capable of mixing fresh fuel and reaction products by using coordinated motion of the displacer pistons 50 and 51 to cause an oscillating flow through the first stage anode passages 35. FIG. 3 illustrates the first of two cycles (labeled “Cycle A”) of this process. In Cycle A, the displacer piston 50 moves up and the displacer piston 51 simultaneously moves down, and as a result, reaction products flow from left to right (as seen in FIG. 3), from the fuel inlet manifold 36 through the first stage anode passages 35, and into the fuel transfer manifold 37. The system volume between the pistons 50 and 51 remains essentially constant during this displacement process. The injector 8 adds fuel 9 during at least a portion of Cycle A such that a mixture of fresh fuel and reaction products flows over and contacts the anode layer of each first stage cell 31. Power is generated and fuel is reformed, and the reforming reaction increases the volume, or number of moles, of gas. The resulting volume expansion pushes a portion of the mixture of fresh fuel and reaction products from the fuel transfer manifold 37 into the second stage anode passages 38. The gas passes once through the second stage anode passages 38 in plug flow mode to increase fuel utilization and power generation, and is exhausted through the fuel exhaust manifold 39.

Cycle B of the push-pull flow mixing system is depicted in FIG. 4. The displacer piston 50 moves down and the displacer piston 51 simultaneously moves up, and as a result, reaction products flow from right to left (as seen in FIG. 4), from the fuel transfer manifold 37 through the first stage anode passages 35, and into the fuel inlet manifold 36. Injection by the injector 8 can be reduced or stopped during Cycle B. Cycle B preferably begins once Cycle A has ended, and the cycles can be continued in sequence. Cycle A and Cycle B do not necessarily have the same lengths, where the cycle and fuel injection timing can be varied according to operating conditions such as electrical load. Preferably the overall cycling rate is rapid enough compared to the time response of the fuel cells such that cell voltage fluctuations fall within acceptable limits.

The heat exchange media 56 and 57, which are optionally provided in the system depicted in FIGS. 3 and 4, can reduce the temperature of gas in contact with the displacer pistons 50 and 51 within cylinders 52 and 53, respectively. As hot gas flows out from the fuel cell through the heat exchange media, the media are heated and the gas entering the volume enclosed by the displacer piston and cylinder is cooled. This reduces the required heat resistance of the displacer pistons and cylinders. When the piston reverses and returns the gas to the fuel cell through the heat exchange media, then the gas is reheated by the sensible heat stored in the media. As a further option, the heat exchange media 56 and 57 can include a reforming catalyst such as nickel.

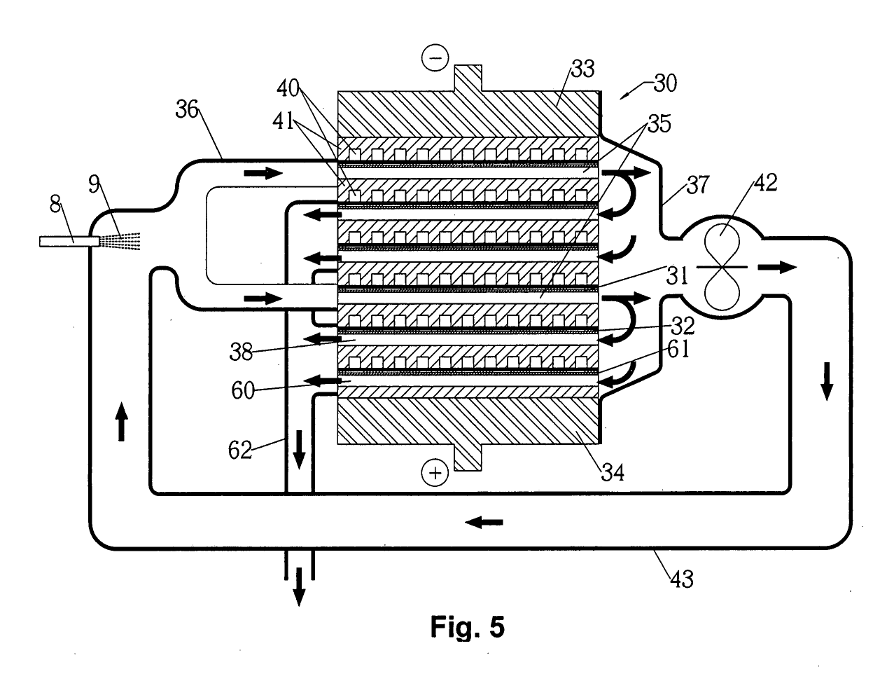

FIG. 5 depicts a recirculating loop flow mixing system according to the present invention in which two second stage fuel cells are provided adjacent to each first stage cell. The cell stack 30 has a cross-flow bipolar design formed of first stage cells 31 alternating with pairs of second stage cells 32 and 61. Conductive separator plates 41 are arranged between the cells 31, 32, and 61 to prevent mixing of the fuel gas streams and the oxidant streams while electrically connecting the cells in series. The cells and separator plates are clamped between power takeoff plates 33 and 34. First stage anode passages 35 in separator plates 41 allow flow of fuel gas from the fuel inlet manifold 36 to the fuel transfer manifold 37 such that the fuel flows along and contacts the anode layer of each first stage cell 31. Second stage anode passages 38 in separator plates 41 allow flow of fuel gas from the fuel transfer manifold 37 to the fuel exhaust manifold 62 such that the fuel flows along and contacts the anode layer of each second stage cell 32 and 61.

Cathode passages 40 are formed in the separator plates 41 perpendicular to the anode passages 35 and 38. The cathode passages pass between the cells 31 and 32, and allow flow of oxidant from an oxidant inlet manifold (not shown) to an oxidant exhaust manifold (not shown). The hot blower 42 and the loop flow duct 43 recirculate a portion of the fuel and reaction product mixture from the fuel transfer manifold 37 to the inlet fuel manifold 36. Hydrocarbon fuel 9 is added to the recirculated mixture by the injector 8 preferably positioned upstream of the fuel inlet manifold 36. The remainder of the fuel and reaction product mixture flows from the fuel transfer manifold 37 into the second stage anode passages 38.

Operation of the recirculating loop flow mixing system depicted in FIG. 5 will now be described. The hot blower 42 creates a recirculating loop flow through the first stage anode passages 35. Fuel 9 is added upstream of the first stage stack fuel inlet manifold 36, such that the fuel is carried into the first stage anode passages 35. The loop flow is large compared to the amount of fuel added, with the result being that the concentration of unreformed fuel entering the stack is low relative to the reaction products. Another result is that the loop flow transfers heat from hot areas to cool areas, thereby making the temperature more uniform. The net effect of the loop flow is that incoming fuel is mixed with the reaction products, facilitating reforming and eliminating soot formation. Addition of new fuel 9 and the resulting reforming and power generation reactions increase the quantity of recirculating gas. Any excess gas can flow from the fuel transfer manifold 37 into the anode passages 38 of the second stage cells 32 and 61. The gas passes once through the second stage anode passages 38 in plug flow mode to increase fuel utilization and power generation, and is exhausted through the fuel exhaust manifold 39. Oxidant is passed through the cathode passages 40 in the cell stack 30. The effect is to increase the active area of the second stage and increase overall fuel utilization.

The provision of two second stage cells for each first stage cell can be varied according to the present invention. In FIG. 5, the reactant gas flow over the anodes of second stage cells 32 is parallel to the reactant gas flow over the anodes of the second stage cells 61. Alternatively, the reactant gas leaving the second stage cells 32 can be directed to flow over the anodes of the second stage cells 61, forming a three-stage series-connected system. Further, mixing may be carried out in stages other than the first stage to achieve more homogeneous conditions across the cell. Moreover, different stage cells may be of different materials. For example, first stage cells might have anode compositions that favor reforming without carbon formation, while later stage cells have anode compositions that optimize power production and are resistant to oxidation at high fuel utilization.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A bipolar fuel cell stack, comprising:
at least two electrochemical power generating fuel cells in thermal contact, wherein at least one of the fuel cells produces heat and at least one of the fuel cells consumes heat.

2. The bipolar fuel cell stack of claim 1, wherein the fuel cells are electrically connected in series.

3. The bipolar fuel cell stack of claim 1, wherein the at least one heat-producing fuel cell and the at least one heat-consuming fuel cell alternate to form a single cell stack.

4. The bipolar fuel cell stack of claim 1, wherein the at least one heat-producing fuel cell generates electric power and reforms hydrocarbon fuel to a fuel gas containing one or more of: hydrogen, carbon monoxide, carbon dioxide, steam, and partially reformed hydrocarbon.

5. The bipolar fuel cell stack of claim 4, and further including a mixing mechanism for forming a mixture of the hydrocarbon fuel, carbon dioxide, and steam such that a concentration of the hydrocarbon fuel relative to the carbon dioxide and the steam does not exceed a set value.

6. The bipolar fuel cell stack of claim 1, and further including:
a manifold and duct structure forming a loop flow path along an anode in the at least one heat-consuming cell, the loop flow path extending at least between an inlet and an outlet of the anode;
a pump positioned within the manifold and duct structure to cause the gas within the loop flow path to pass along the anode;
an injection device for adding fuel to the gas in the loop flow path upstream of the anode inlet; and
at least one passage extending from the anode outlet to the anode inlet, thereby connecting the loop flow path with the injection device.

7. The bipolar fuel cell stack of claim 1, and further including:
a first manifold and duct structure forming a first flow path between an anode outlet of the at least one heat-consuming cell and a first displacer piston and cylinder assembly;
a second manifold and duct structure forming a second flow path between an anode inlet of the at least one heat-consuming cell and a second displacer piston and cylinder assembly, such that a continuous flow path is formed by the first and second flow paths to connect the first and second piston and cylinder assemblies;
a mechanism that reciprocates the displacer pistons with amplitude and phase such that gas passes over the anodes of the at least one heat-consuming cell as a periodically reversing flow; and
an injection device for adding fuel to the gas in the flow path upstream of the anode inlet of the at least one heat-consuming cell.

8. The bipolar fuel cell stack of claim 7, wherein solid heat exchanger media are inserted in flow ducts between the displacer piston and cylinder assemblies and the manifold and duct structures.

9. The bipolar fuel cell stack of claim 8, wherein the solid heat exchange media include fuel reforming catalyst material.

10. The bipolar fuel cell stack of claim 7, wherein the fuel delivery rate of the injection device varies in a cyclic pattern synchronized with the periodically reversing gas flow.

11. The bipolar fuel cell stack of claim 1, wherein the at least one heat-producing fuel cell generates electric power from fuel gas.

12. The bipolar fuel cell stack of claim 11, wherein the fuel gas comprises at least one of hydrogen, carbon monoxide, and partially reformed hydrocarbon.

13. The bipolar fuel cell stack of claim 1, wherein the at least one heat-consuming cell generates electric power and reforms hydrocarbon fuel to a fuel gas containing hydrogen, carbon monoxide and partially reformed hydrocarbon, and wherein the fuel gas is subsequently used to generate electric power in the at least one heat-producing cell.

14. A recirculating loop flow mixing system, comprising:
a plurality of first stage fuel cells, each formed with an anode passage;
a plurality of second stage fuel cells, each formed with an anode passage, the second stage fuel cells being connected in series with the first stage fuel cells;
a mixing mechanism for producing a recirculating loop flow through the anode passages of the first stage fuel cells;
an injector for injecting fuel into the first stage fuel cells; and
at least one passage operably connecting the mixing mechanism with the injector and the anode passages of the first stage fuel cells, thereby forming a continuous loop.

15. The recirculating loop flow mixing system of claim 14, wherein the injector is positioned upstream of the anode passages of the first stage fuel cells.

16. The recirculating loop flow mixing system of claim 14, wherein the first stage fuel cells and the second stage fuel cells alternate in a single bipolar stack.

17. The recirculating loop flow mixing system of claim 16, wherein the mixing mechanism is positioned outside the single bipolar stack.

18. The recirculating loop flow mixing system of claim 14, wherein each first stage fuel cell alternates with at least two second stage fuel cells in a single bipolar stack.

19. The recirculating loop flow mixing system of claim 14, and further including conductive separator plates positioned between the first and second stage fuel cells.

20. The recirculating loop flow mixing system of claim 14, wherein the mixing mechanism is selected from the group consisting of: a blower, a jet pump, and a mechanical mixer.

21. A push-pull loop flow mixing system, comprising:
a plurality of first stage fuel cells, each formed with an anode passage;
a plurality of second stage fuel cells, each formed with an anode passage, the second stage fuel cells being connected in series with the first stage fuel cells;
a first manifold and duct structure forming a first flow path downstream of the anode passages of the first stage cells to a first displacer piston and cylinder assembly;
a second manifold and duct structure forming a first flow path upstream of the anode passages of the first stage cells to a second displacer piston and cylinder assembly;
a mechanism that reciprocates the displacer pistons with amplitude and phase such that gas passes through the anode passages of the first stage fuel cells as a periodically reversing flow; and
an injector for injecting fuel into the first stage fuel cells.

22. The push-pull loop flow mixing system of claim 21, wherein solid heat exchanger media are inserted in flow ducts between the displacer piston and cylinder assemblies and the manifold and duct structures.

23. The push-pull loop flow mixing system of claim 21, wherein the solid heat exchange media include fuel reforming catalyst material.

24. The push-pull loop flow mixing system of claim 21, wherein the fuel delivery rate of the injection device varies in a cyclic pattern synchronized with the periodically reversing gas flow.

25. The push-pull loop flow mixing system of claim 21, wherein the injector is positioned upstream of the anode passages of the first stage fuel cells.

26. The push-pull loop flow mixing system of claim 21, wherein the first stage fuel cells and the second stage fuel cells alternate in a single bipolar stack.

27. The push-pull loop flow mixing system of claim 26, wherein the mixing mechanism is positioned outside the single bipolar stack.

28. The push-pull loop flow mixing system of claim 21, and further including conductive separator plates positioned between the first and second stage fuel cells.

29. A method of producing electric power from the reaction of hydrocarbon fuel with oxidant in a closely spaced array of electrochemical fuel cells, comprising:
endothermic reforming of the hydrocarbon fuel over the anodes of a first set of electrochemical fuel cells, wherein the hydrocarbons are partially oxidized to fuel gas containing carbon monoxide hydrogen, carbon dioxide and water vapor, and electric power is generated;
exothermic oxidation of the fuel gas over the anodes of a second set of electrochemical fuel cells interspersed among the first set of electrochemical cells, wherein carbon monoxide, hydrogen, and remaining hydrocarbons are further oxidized to carbon dioxide and water vapor, and additional electric power is generated;
oxidant reduction at cathode surfaces of the electrochemical fuel cells; and
transferring sensible heat from said second set of electrochemical fuel cells to the first set of electrochemical cells.

30. The method of claim 29, wherein the gas and hydrocarbon fuel are mixed over the anodes of the first set of electrochemical fuel cells such that the local concentration of fuel relative to the carbon dioxide and steam in the mixture contacting the anodes does not exceed a set value.

31. The method of claim 29, wherein the oxidant passes over the cathode surfaces of the second set of electrochemical fuel cells before passing over the cathode surfaces of the second set of electrochemical fuel cells.

32. The method of claim 29, wherein the electrochemical fuel cells are electrically connected in series.
